(19) United States
(12) Patent Application Publication
(10) Pub. No.: US 2007/0055530 A1
(43) Pub. Date: Mar. 8, 2007

(54) Update data generating apparatus, update data generating method, update data generating program, method for updating speaker verifying apparatus and speaker identifier, and program for updating speaker identifier

(75) Inventor: Yoshifumi Onishi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/505,391

(22) Filed: Aug. 17, 2006

(30) Foreign Application Priority Data
Aug. 23, 2005 (JP) 2005-241761

(51) Int. Cl. G10L 21/00

(52) U.S. Cl. 704/275

(57) ABSTRACT

It is to provide a speaker verifying apparatus and the like capable of updating the identifier of a registering speaker at a low cost, considering that voices change over time. An update data generating apparatus comprises functions of: inputting registering speaker's voice feature value data to the speaker identifier of the registering speaker to obtain hypothesis scores, and generating a registering speaker score vector string constituted with a plurality of vectors having the hypothesis scores as the elements; inputting background speaker's voice feature value data to the speaker identifier of the registering speaker to obtain hypothesis scores, and generating a background speaker score vector string constituted with a plurality of vectors having the hypothesis scores as the elements; and storing the registering speaker score vector string and the background speaker score vector string to a storage device.

### BACKGROUND OF THE INVENTION

### Field of the Invention

The present invention relates to a speaker verification technique and, more particularly, to an update data generating method effective for updating a speaker identifier that is constituted with weighted sum of a plurality of hypotheses and to an updating method and the like of the speaker identifier using the aforementioned update data.

Non-Patent Literature 1 mentions an example of a conventional method for verifying a speaker. FIG. 7 shows a speaker identifier learning apparatus using that method. The speaker identifier learning apparatus shown in FIG. 7 is constituted with a voice input part 301, a voice analyzing unit 302, a speaker identifier learning unit 303, a background speaker data storage part 304, and a speaker identifier storage part 305.

FIG. 8 shows a speaker verifying apparatus using the conventional speaker verifying method. The speaker verifying apparatus shown in FIG. 8 is constituted with a voice input part 401, a voice analyzing unit 402, a speaker verifying unit 403, a speaker identifier storage part 405, and a verification result output part 404.

The conventional speaker identifier learning apparatus and the speaker verifying apparatus having such configuration operate as follows.

That is, when registering a speaker, voice of the registering speaker is inputted from the voice input part 301, which is converted into feature value data by the voice analyzing unit 302. By using the converted feature value data of the voice of the registering speaker and background speaker voice feature value data that is the feature value data of phonations of an unspecified large number of speakers stored in the background speaker data storage part 304, the speaker identifier learning unit 303 learns the speaker identifier that discriminates the registering speaker's voice from the background speakers' voices as the voices of the other speakers, and the identifier of the registering speaker is stored in the speaker identifier storage part 305.

When verifying the speaker, the voice of the verifying speaker is inputted from the voice input part 401, which is converted into feature value data by the voice analyzing unit 402. By using the verifying voice feature value data and the identifier of a claimed speaker that the verifying speaker claims as he or she is stored in the speaker identifier storage part 405, the speaker verifying unit 403 judges whether or not the voice of the verifying speaker is the same as that of the claimed speaker. The verification result is outputted to the verification result output part 404.

The conventional speaker identifier learning unit 303 will be described.

The learning data can be expressed by Expression 1, in which x indicates the voice feature value data and y indicates a teacher class label. It is noted that y is +1 for the registering speaker's voice and −1 for the background speaker's voice.
(x₁,y₁), . . . , (x_{N},y_{N}) [Expression 1]

Further, it is noted that the number of registering speaker's voice feature data is Na, the number of background speakers' voice feature data is Nb, and the total number of learned data is expressed as N=Na+Nb. The speaker identifier to be learned is expressed by Expression 2. An identifier H (x) is constituted with weighted (αm) sum of M-number of hypotheses hm(x).

$$H ( x ) = {\sum }_{m = 1}^{M} {α}_{m} {h}_{m} ( x ) , {h}_{m} ( x ) ∈ [ - 1.1 ] \qquad [ Expression 2 ]$$

“hm(x)” and “αm” are so determined in the identifier learning that the loss function (Expression 3) is minimized with respect to the learned data.

$$\frac{1}{N} {\sum }_{i = 1}^{N} exp [ - {y}_{i} H ( {x}_{i} ) ] \qquad [ Expression 3 ]$$

The “hm(x)” and “αm” are determined by using AdaBoost algorithm.

Each hypothesis hm(x) is a function that outputs an actual number value of −1 to 1 for input data x. When the output value is not negative, it is judged as the registering speaker's voice. When negative, it is judged as other speaker's voice. The output value of each hypothesis hm(x) is referred to as a hypothesis score.

In the conventional method, it is not necessary for the hypothesis hm(x) to have sufficiently fine judgment accuracy. Even with a poor judgment accuracy, it is possible to provide an identifier H(x) with a fine identifying accuracy, which is constituted with weighted sum of a plurality of hypotheses using the registering speaker's voice and the background speakers' voice.

In the speaker verifying unit 403, there is inputted verifying voice data to the identifier H(x) of the claimed speaker. The score is compared to a threshold value for judging whether or not the verifying voice can be considered as the same as that of the claimed speaker.

[Non-Patent Literature 1]

Stan Z. Li, Dong Zhang, Chengyuan Ma, Heung-Yeung Shum, and Eric Chang, “Learning to Boost GMM Based Speaker Verifications”, Proceedings of EUROSPEECH Conference 2003.

The first shortcoming of the above-described conventional speaker identifier is that deterioration of the performance becomes large when there is a considerable length of time between the registration and verification.

It is known that there is generated fluctuation in voices over time. Thus, when there is a large fluctuation between the voice at the time of registration and the voice at the time of verification, there are many cases where the speaker is rejected by mistake even he or she is the speaker himself or herself. This is because learning of the conventional identifier is set to discriminate the registering speaker's voice and the background speaker's voice.

The second shortcoming is that it requires a high cost for performing re-learning and update of the identifier.

The reason is that it is necessary in the conventional identifier learning method to have the background speakers' data stored and there requires a large amount of calculation for learning the speaker identifier constituted with weighted sum of a plurality of hypotheses.

### SUMMARY OF THE INVENTION

The object of the present invention therefore is to provide a speaker verifying apparatus and the like capable of updating an identifier of a registering speaker at a low cost, considering that the voices change over time.

The update data generating apparatus of the present invention comprises an update data generating unit for generating a registering speaker score vector string and a background speaker score vector string by inputting voice feature value of the registering speaker and the voice feature value of the background speaker to a speaker identifier of the registering speaker.

The registering speaker score vector string and the background speaker score vector string generated by the above-described update data generating apparatus statistically show the tendency of scores that can be obtained when the voice feature value of the registering speaker and the voice feature value of the background speaker other than the registering speaker are inputted to the speaker identifier of the registering speaker. Therefore, the use of these data enables update of the speaker identifier while considering the changes in the voice of the registering speaker over time, etc. without using the voice feature value itself of the background speaker.

Further, the data size of the registering speaker score vector string and the background speaker score vector string is smaller than the data size of the voice feature values of a great number of background speakers. Thus, it is possible to reduce the memory capacity for holding the data necessary to update the speaker identifier.

In the update data generating apparatus, sufficient statistics of distributions in vector spaces of the registering speaker score vector string and the background speaker score vector string may be calculated.

With this, it is possible to reduce the memory capacity for holding the data necessary to update the speaker identifier compared to the case of storing the score vector strings themselves.

In the update data generating apparatus, as the sufficient statistics, there may be calculated: number of the registering speaker's voice feature value data; number of the background speaker's voice feature value data; an average value of the score vector string of the registering speaker; an average value of the score vector string of the background speaker; an average value of vectors obtained by multiplying a score vector of the registering speaker and an inverted vector of the vector; and an average value of vectors obtained by multiplying a score vector of the background speaker and an inverted vector of the vector.

With this, it is possible to calculate the hypothesis score distributions from the sufficient statistics assuming that the distribution of the hypothesis scores is the normal distribution.

The voice verifying apparatus of the present invention comprises an update data storage part to which the registering speaker score vector string and the background speaker score vector string are stored in advance. An update data updating unit: inputs the feature value data of the voice of the verifying speaker whose legitimacy is confirmed to the M-number of hypotheses constituting the speaker identifier of the verifying speaker so as to obtain the hypothesis scores as the output thereof; generates the verifying speaker score vector string constituted with a plurality of vectors having the hypothesis scores as the elements; and updates the registering speaker score vector string by combining the vectors with the registering speaker score vector string stored in the update data storage part. A speaker identifier updating unit obtains M-dimensional vectors in the projection direction by applying an optimum separating problem of two classes in an M-dimensional space to the updated registering speaker score vector string and the background speaker score vector string, and updates the speaker identifier of the verifying speaker by using each element of the obtained vectors as the weight.

In the above-described speaker verifying apparatus, the registering speaker score vector string is updated with the verifying speaker score vector string obtained at the time of verification, and the speaker identifier of the verifying speaker is updated based on the updated registering speaker score vector string and the background speaker score vector string.

Therefore, the voice identifier of the verifying speaker can be updated by corresponding to changes in the voice of the verifying speaker over time without storing the voice feature values of the background speakers.

In the above-described voice verifying apparatus, the update data storage part may have sufficient statistics of distributions in the vector spaces of the registering speaker score vector string and the background speaker score vector string stored therein in advance, and the speaker identifier updating unit may calculate the distributions of the verifying speaker score vector string and the background speaker score vector string based on the sufficient statistics.

With this, it is possible to reduce the necessary memory capacity compared to the case of storing the score vector strings themselves as the data for updating the speaker identifier.

In the above-described voice verifying apparatus, as the sufficient statistics, there may be stored: number of the registering speaker's voice feature value data; number of the background speaker's voice feature value data; an average value of the score vector string of the registering speaker; an average value of the score vector string of the background speaker; an average value of vectors obtained by multiplying a score vector of the registering speaker and an inverted vector of the vector; and an average value of vectors obtained by multiplying a score vector of the background speaker and an inverted vector of the vector, and the speaker identifier updating unit may: generate M-dimensional normal distributions from those data; calculate, based on the M-dimensional normal distributions, unidimensional projection where separation of the registering speaker score vector string and the background speaker score vector string becomes optimum; and update the speaker identifier of the verifying speaker by using, as the weight, each element of vectors obtained by normalizing the norm of M-dimensional vectors indicating direction of the projection as “1”.

With this, the speaker identifier can be updated assuming that the distribution of the score vectors is the normal distribution.

The method for generating speaker identifier update data according to the present invention comprises the steps of: obtaining registering speaker's voice feature value data and inputting the registering speaker's voice feature value data to the speaker identifier of a registering speaker to obtain hypothesis scores as an output of the plurality of hypotheses, and generating a registering speaker score vector string constituted with a plurality of vectors having the hypothesis scores as the elements; obtaining background speaker's voice feature value data and generating a background speaker score vector string in the same manner described above; and calculating sufficient statistics of distributions in the vector spaces of the registering speaker score vector string and the background speaker score vector string, and recording the sufficient statistics to a storage device as the speaker identifier update data.

The registering speaker score vector string and the background speaker score vector string generated by the above-described method for generating the update data statistically show the tendency of scores that can be obtained when the voice feature value of the registering speaker and the voice feature value of the background speaker other than the registering speaker are inputted to the speaker identifier of the registering speaker. The distributions of the score vectors can be calculated from the sufficient statistics generated from those score vector strings. Therefore, the use of the sufficient statistics calculated by this method enables update of the speaker identifier while considering the changes in the voice of the registering speaker over time, etc. without using the voice feature value of the background speaker itself.

Further, the data size of the sufficient statistics is smaller than the data size of the voice feature values of a great number of background speakers. Thus, it is possible to reduce the memory capacity for holding the data necessary to update the speaker identifier.

The method for updating a speaker identifier according to the present invention comprises the steps of: a speaker verifying step for judging legitimacy of a verifying speaker by using the speaker identifier; inputting voice feature value data of the verifying speaker to the speaker identifier of the verifying speaker to obtain hypothesis scores as an output result thereof when legitimacy of the verifying speaker is confirmed in the speaker verifying step, and generating verifying speaker score vector string constituted with a plurality of vectors having the hypothesis scores as elements; a sufficient statistic calculating step for calculating verifying speaker sufficient statistic that shows distribution in the vector space of the verifying speaker score vector string; an update data updating step for updating the update data by combining verifying speaker sufficient statistic and the update data stored in a storage device in advance, and storing the updated update data to the storage device; a distribution calculating step for calculating distributions of the verifying speaker and a background speaker based on the update data that is updated in the update data updating step; and a speaker identifier updating step for calculating, based on the distributions, unidimensional projection where separation of the verifying speaker score vector and the background speaker score vector becomes optimum, and updating the speaker identifier of the verifying speaker by using each element of the vector indicating direction of the projection as the weight.

With the above-described method for updating s speaker identifier, the voice feature value of the verifying speaker obtained at the time of verification can the reflected upon the update data of the speaker identifier. Furthermore, it becomes possible to calculate the distributions of the score vectors using the latest update data without using the voice feature value data of the background speaker, and to update the speaker identifier of the verifying speaker based on the distributions.

Therefore, it is possible to reduce the memory capacity of the storage device for carrying the data for updating while enabling update of the speaker identifier by corresponding to fluctuation in the voice of the speaker due to changes over time or the like.

The program for generating speaker identifier update data according to the present invention is used in a computer to execute functions of: obtaining registering speaker's voice feature value data and inputting the registering speaker's voice feature value data to the speaker identifier of the registering speaker to obtain hypothesis scores as an output of the plurality of hypotheses, and generating a registering speaker score vector string constituted with a plurality of vectors having the hypothesis scores as elements; obtaining background speaker's voice feature value data and inputting the background speaker's voice feature value data to the speaker identifier of the registering speaker to obtain hypothesis scores as an output of the plurality of hypotheses, and generating a background speaker score vector string constituted with a plurality of vectors having the hypothesis scores as elements; and calculating sufficient statistics of distributions in vector spaces of the registering speaker score vector string and the background speaker score vector string, and recording the sufficient statistics to a storage device as the speaker identifier update data.

With the above-described program, the computer can be used to operate as the device for generating the speaker identifier update data in order to generate, as the update data, the sufficient statistics showing the distribution of the scores as the output of the hypotheses that constitute the speaker identifier. The distribution of the score vectors can be calculated from those sufficient statistics.

Therefore, the use of the sufficient statistics calculated by the above-described program enables update of the speaker identifier while considering the changes in the voice of the registering speaker over time, etc. without using the voice feature value of the background speaker itself.

Further, the data size of the sufficient statistics is smaller than the data size of the voice feature values of a great number of background speakers. Thus, it is possible to reduce the memory capacity for holding the data necessary to update the speaker identifier.

The program for updating a speaker identifier according to the present invention according to the present invention is used in a computer to execute functions of: a speaker verifying function for judging legitimacy of a verifying speaker by using the speaker identifier; inputting voice feature value data of the verifying speaker to the speaker identifier of the verifying speaker to obtain hypothesis scores as an output result thereof when legitimacy of the verifying speaker is confirmed by the speaker verifying function, and generating verifying speaker score vector string constituted with a plurality of vectors having the hypothesis scores as elements; a sufficient statistic calculating function for calculating verifying speaker sufficient statistic that shows distribution in a vector space of the verifying speaker score vector string; an update data updating function for updating the update data by combining verifying speaker sufficient statistic and the update data stored in a storage device in advance, and storing the updated update data to the storage device; a distribution calculating function for calculating distributions of the verifying speaker and a background speaker based on the update data that is updated by the update data updating function; and a speaker identifier updating function for calculating, based on the distributions, unidimensional projection where separation of the registering speaker score vector and the background speaker score vector becomes optimum, and updating the speaker identifier of the verifying speaker by using each element of the vectors indicating direction of the projection as the weight.

With the above-described program for updating a speaker identifier, the computer can be used to operate as the device for updating the speaker identifier, and the voice feature value of the verifying speaker obtained at the time of verification can the reflected upon the update data of the speaker identifier. Furthermore, it becomes possible to calculate the distributions of the score vectors using the latest update data without using the voice feature value data of the background speaker, and to update the speaker identifier of the verifying speaker based on the distributions.

Therefore, it is possible to reduce the memory capacity of the storage device for carrying the data for update while enabling update of the speaker identifier by corresponding to fluctuation in the voice of the speaker due to changes over time or the like.

With the present invention, the update data generating apparatus can generate the registering speaker score vector string and the background speaker score vector string that show the statistic tendencies of the scores of the voice feature values of the background speaker and the registering speaker.

Therefore, the use of those data enables update of the speaker identifier while considering the changes in the voice of the registering speaker over time, etc. without using the voice feature value of the background speaker itself.

Furthermore, the data size of the registering speaker score vector string and the background speaker score vector string is smaller than the data size of the voice feature values of a great number of background speakers. Thus, it is possible to reduce the memory capacity for holding the data necessary to update the speaker identifier.

### BRIEF DESCRIPTION OF THE DRAWINGS

FIG. 1 is a general view of a speaker verifying system as an embodiment of the present invention;

FIG. 2 is a functional block diagram of a speaker registering apparatus;

FIG. 3 is an illustration for showing sufficient statistics stored in a hypothesis score distribution storage part;

FIG. 4 is a functional block diagram of a speaker verifying apparatus;

FIG. 5 is a flowchart for showing action of the speaker registering apparatus;

FIG. 6 is a flowchart for showing action of the speaker verifying apparatus;

FIG. 7 is a functional block diagram of a conventional speaker identifier learning apparatus; and

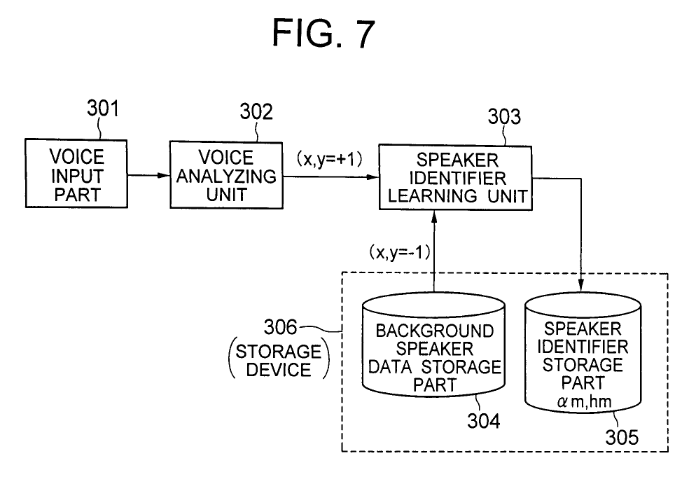

FIG. 8 is a functional block diagram of a conventional speaker verifying apparatus.

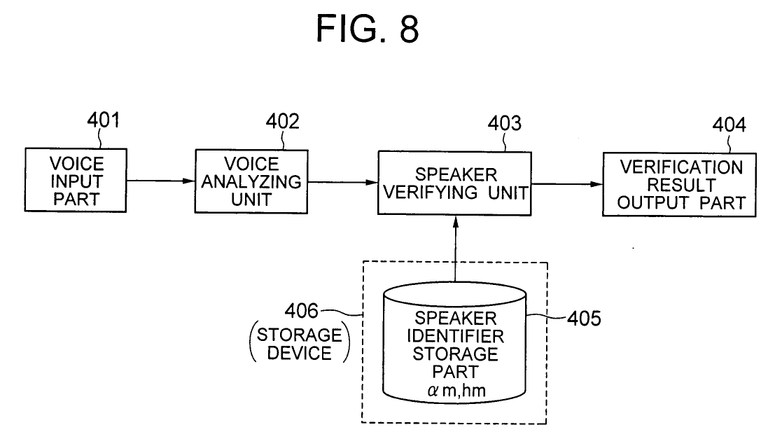

### DETAILED DESCRIPTION OF THE PREFERRED EMBODIMENTS

In the followings, there will be described the structure and operation of a speaker verifying system 1 as an embodiment of the present invention by referring to the accompanying drawings.

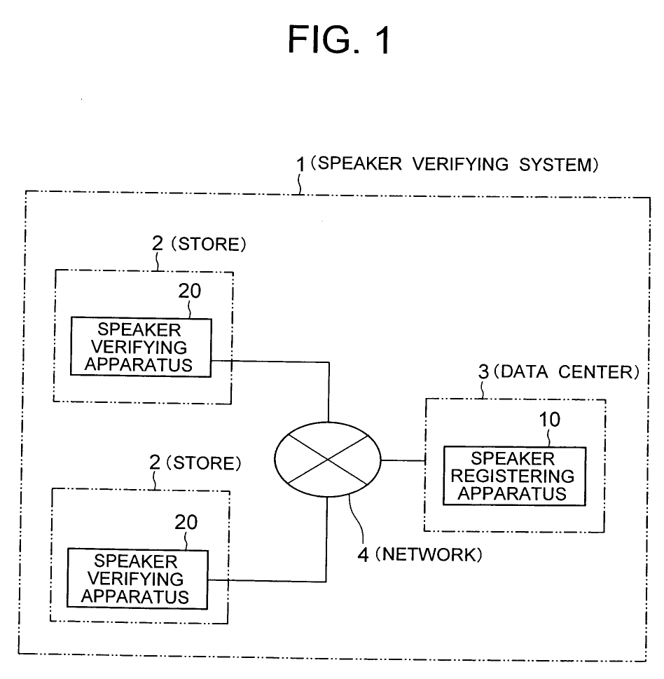

FIG. 1 is a schematic view for showing the overall structure of the speaker verifying system 1. The speaker verifying system 1 comprises a speaker registering apparatus (update data generating apparatus) 10 provided at a data center 3 and speaker verifying apparatuses 20 provided at a plurality of stores 2. The speaker registering apparatus 10 and the speaker verifying apparatus 20 can communicate with each other through a network 4.

A user (speaker), first, inputs one's own voice to the speaker registering apparatus 10 to be registered. At this time, the speaker registering apparatus 10 learns a speaker identifier necessary for verifying the speaker and generates hypothesis score distribution necessary for updating the speaker identifier.

For the speaker to input the voice, the speaker may go to the data center 3 and directly input the voice data of the speaker to the speaker registering apparatus 10 or may input the voice data of the speaker to the speaker verifying apparatus 20 or to other communication terminal and transfer it to the speaker registering apparatus 10 via the network 4.

The speaker identifier and the hypothesis score distribution generated by the speaker registering apparatus 10 may be distributed to the speaker verifying apparatuses 20 via the network 4. Alternatively, a recording medium having those data stored therein may be distributed.

The speaker who has been registered inputs the voice to the speaker verifying apparatus 20 for receiving authentication when using a credit card at the store 2, for example. The speaker verifying apparatus 20 judges the probability that the inputted voice is considered as the voice of the registering speaker, and authenticates the speaker when the probability is high. Further, the speaker verifying apparatus 20 also performs update of the hypothesis score distribution and the speaker identifier.

(Structure of Speaker Registering Apparatus 10)

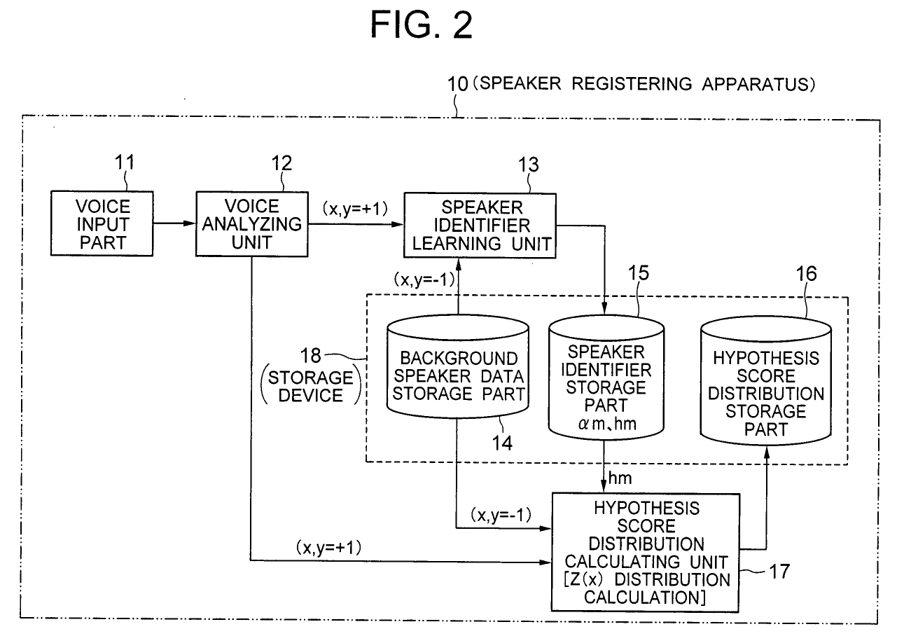

FIG. 2 is a functional block diagram for showing the structure of the speaker registering apparatus 10.

The speaker registering apparatus 10 comprises a voice input part 11, a voice analyzing unit 12, a speaker identifier learning unit 13, a background speaker data storage part 14, a hypothesis score distribution calculating unit (update data generating unit) 17, and a storage device 18.

The storage device 18 is a hard disk drive, for example, which comprises the background speaker data storage part 14, a speaker identifier storage part 15, and a hypothesis score distribution storage part 16.

The feature value data (background speakers' voice feature value data) of the voice spoken by speakers other than the registering speaker is stored in the background speaker data storage part 14 in advance. The data is used for learning the speaker identifier of the registering speaker.

The speaker identifier that has been learned by the speaker identifier learning unit 13 is stored in the speaker identifier storage part 15.

The hypothesis score distribution that is calculated by the hypothesis score distribution calculating unit 17 is stored in the hypothesis score distribution storage part 16.

The voice input part 11 is constituted with a microphone, for example, which converts the voice of the registering speaker inputted as sound waves into electric signals and output them to the voice analyzing unit 12.

The voice analyzing unit 12 analyzes the voice (the registering speaker's voice) inputted from the voice input part and converts it to the feature value data (the voice feature value data of the registering speaker). This conversion is performed by cepstrum analysis or the like as in the case of obtaining the feature value for voice recognition and speaker verification in general, for example.

The feature value data is expressed by Expression 1 like the conventional case.

The speaker identifier learning unit 13 learns the speaker identifier for discriminating the registering speaker from other speakers by using the feature value data of the registering speaker's voice and the feature value data of the background speakers' voices stored in the background speaker data storage part 14, and stores the speaker identifier for identifying the registering speaker in the speaker identifier storage part 15.

The speaker identifier is expressed by Expression 2, which is constituted with weighted (αm) sum of M-number of hypotheses hm(x). The speaker identifier learning unit 13 carries out learning so as to minimize the loss function (see Expression 3) of the learning data by using the AdaBoost algorithm in the manner depicted in Non-Patent Literature 1, for example.

The hypothesis score distribution calculating unit 17 converts the registering speaker's voice feature value data and the background speakers' voice feature value data stored in the background speaker data storage part 14 into a vector string of a plurality of hypothesis scores of the learned speaker identifier of the registering speaker, and stores the sufficient statistics of the distributions in the hypothesis score vector space of the vector string to the hypothesis score distribution storage part 16, respectively.

The hypothesis score vector string is expressed by Expression 4, which is expressed as z(x) that is constituted with the vector string of the hypothesis scores for the M-number of hypotheses that constitute the identifier with respect to the inputted feature value data x. The hypothesis score distribution calculating unit 17 finds a set {Z} of the hypothesis score vectors from a set {x} of the inputted feature value data, and calculates the sufficient statistics of the estimated distributions for each teacher class label, i.e. for every y=+1 and y=−1.

When it is assumed that the distribution in the hypothesis score vector space is M-dimensional normal distribution, for example, as the sufficient statistic, the hypothesis score distribution calculating unit 17 calculates and stores the number Nz of the inputted feature value data, the average value <z> of the hypothesis score vector string expressed by Expression 5, and the average value of the matrixes of the products of the hypothesis score vectors expressed by Expression 6 for each teacher class label. It is noted that the superscript “t” of “z” shows inversion of the vector (the same applies to Expression 7 and Expressions thereafter.

Alternatively, the set of the hypothesis score vectors itself may be stored in the hypothesis score distribution storage part 16 by each teacher class without assuming the distribution of the set of the hypothesis score vectors.

$$\begin{matrix}Z ( x ) = ( {h}_{1} ( x ) , {h}_{2} ( x ) , ⋯ , {h}_{M} ( x ) ) & [ Expression 4 ] \\ 〈 Z 〉 = \frac{1}{{N}_{z}} {\sum }_{i = 1}^{{N}_{z}} Z ( {x}_{i} ) & [ Expression 5 ] \\ 〈 {Z}^{t} Z 〉 = \frac{1}{{N}_{z}} {\sum }_{i = 1}^{{N}_{z}} {Z ( {x}_{i} )}^{t} Z ( {x}_{i} ) & [ Expression 6 ]\end{matrix}$$

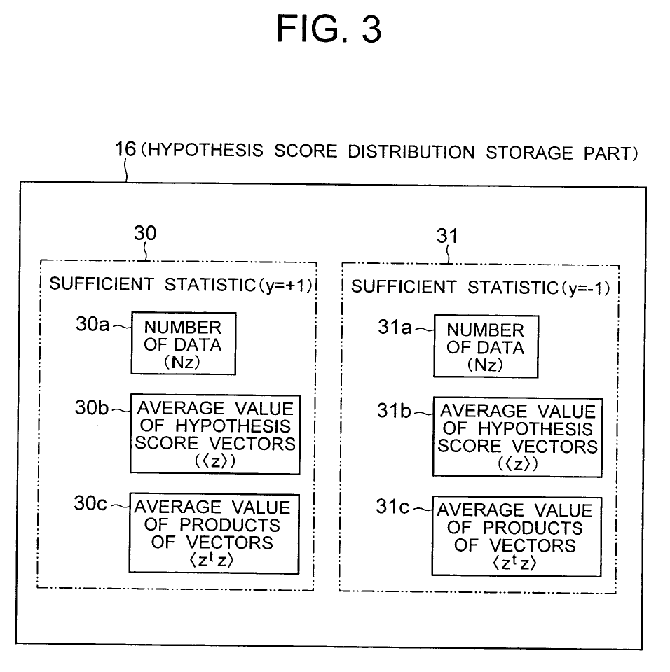

FIG. 3 is a schematic illustration for showing an example of data to be stored in the hypothesis score storage part 16. In the hypothesis score storage part 16, there are stored the sufficient statistic of the distributions in the hypothesis score vector space of the hypothesis score vector string (simply referred to as the sufficient statistics hereinafter) 30 corresponding to the data of the teacher class label y=+1, and the sufficient statistic 31 corresponding to the data of the teacher class label y=−1, respectively.

The sufficient statistic 30 contains the data number (Nz) 30a showing the number of the inputted feature value data with the teacher class label of +1, the hypothesis score vector average value (<z> of Expression 5) 30b, and the average value of the matrixes of the products of the hypothesis score vectors (<z^{t}z> of Expression 6) 30c.

Similarly, the sufficient statistic 31 contains the data number (Nz) 31a showing the number of the inputted feature value data with the teacher class label of −1, the hypothesis score vector average value (<z> of Expression 5) 31b, and the average value of the matrixes of the products of the hypothesis score vectors (<z^{t}z> of Expression 6) 31c.

Looking into the approximate sizes of each data, Nz 30a and 30b are integers so that each of the data is about 4 byte. <Z>30b and 31b are vectors having the M-number of actual numbers as elements so that, assuming that M is 10, each data is about 40 (4×10) byte and <Z^{t}z> is about 400 (4×10×10) byte since it is the matrix of M-columns×M-rows. That is, the data size of the sufficient statistics stored in the hypothesis score distribution storage part 16 do not even add up to 1K byte.

In the meantime, the data size of the background speakers adds up to as high as 3.8G byte (2×1000×120×100×40×4) assuming that there are provided data for a hundred and twenty seconds for a thousand speakers each for male and female, and a hundred frames per second for forty dimensions.

As described above, the present invention allows a dramatic reduction of the data size that is required for updating the speaker identifier, compared to the case of using the background speaker data.

The speaker registering apparatus 10 shown in FIG. 2 is built as the structure of hardware in the above. However, the speaker registering apparatus 10 may be constituted with a computer, and have the CPU of the computer read out the speaker registering program successively, and executes the functions of the voice analyzing unit 12, the speaker identifier learning unit 13, and the hypothesis score distribution calculating unit 17 on the software. In that case, the voice input part 11 is constituted with an acousto-electric converter in order to capture the voice data into the computer. Furthermore, the storage device 18 containing the background speaker data storage part 14, the speaker identifier storage part 15, and the hypothesis score distribution storage part 16 is constituted with a hard disk drive, for example.

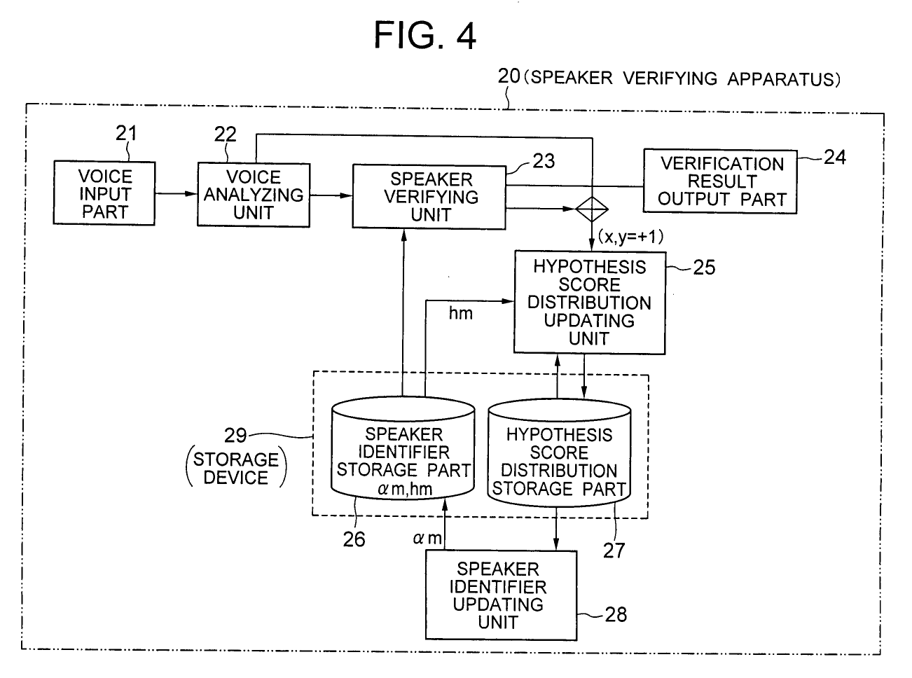

FIG. 4 is a functional block diagram for showing the structure of the speaker verifying apparatus 20.

The speaker verifying apparatus 20 comprises a voice input part 21, a voice analyzing unit 22, a speaker verifying unit 23, a verification result output part 24, a hypothesis score distribution updating unit 25, a speaker identifier updating unit 28, a speaker identifier storage part 26, a hypothesis score distribution storage part 27, and a storage device 29.

The voice input part 21 is constituted with a microphone, for example, which converts the voice of the verifying speaker (verifying speaker's voice) inputted as sound waves into electric signals and output them to the voice analyzing unit 22.

The voice analyzing unit 22 analyzes the voice inputted from the voice input part and converts it to the feature value data.

The speaker verifying unit 23 judges whether or not the verifying voice can be considered as the voice spoken by the claimed speaker by using the feature value data of the verifying voice and the speaker identifier of the claimed speaker the speaker claims as his or hers stored in the speaker identifier storage part 26. This judgment is performed by inputting the verifying voice data to the identifier of the claimed speaker and comparing the outputted score with the threshold value.

The verification result output part 24 informs the verification result given by the speaker verifying unit to the speaker by outputting it as an image to a display device, for example.

The hypothesis score distribution updating unit 25 converts the feature value data for updating the speaker identifier, which is judged by the speaker verifying unit 23 as the data of the same speaker, into a vector string of the hypothesis scores corresponding to a plurality of hypotheses that constitute the identifier of the claimed speaker so as to update the sufficient statistic 30 of the hypothesis score distribution of the class label y=+1 of the claimed speaker, which is stored in the hypothesis score distribution storage part 27.

That is, first, the one that is judged as the same as that of the claimed speaker among the inputted verifying voice data string is considered as {x′}, and {x′} is converted into a set {z′} of hypothesis score vectors of each hypothesis that constitutes the identifier of the claimed speaker.

Then, the sufficient statistic of the distribution in the hypothesis score vector space of the {z′} is calculated, which is combined with the sufficient statistic 30 of the hypothesis score distribution of the class label y=+1 of the claimed speaker stored in the hypothesis score distribution storage part 27 for update.

For example, when it is assumed that the hypothesis score distribution is M-dimensional normal distribution, the average value of the hypothesis score vectors is updated with Expression 7, the average value of the product matrixes of the hypothesis score vectors with Expression 8, and the number of the feature value data with Expression 9. “Nz′” in Expression 9 is the number of elements of the feature value data for updating the speaker identifier.

Alternatively, when the distribution of the set of the hypothesis score vectors is not hypothesized, the set of the score vectors itself is combined for update.

As still another alternative, as the feature value data for updating the speaker identifier inputted to the hypothesis score distribution updating unit 25, the voice data whose legitimacy is confirmed by authentication through an external speaker authentication system or an input of a password by the user is used to update the speaker identifier.

$$\begin{matrix}〈 z 〉 ← \frac{1}{{N}_{z} + {N}_{z}} ( {N}_{z} 〈 z 〉 + {N}_{{z}^{′}} {〈 z 〉}^{′} ) & [ Expression 7 ] \\ 〈 {z}^{t} z 〉 ← \frac{1}{{N}_{z} + {N}_{z}} ( {N}_{z} 〈 {z}^{t} z 〉 + {N}_{{z}^{′}} {〈 {z}^{t} {z}^{′} 〉}^{′} ) & [ Expression 8 ] \\ {N}_{z} ← {N}_{z} + {N}_{{z}^{′}} & [ Expression 9 ]\end{matrix}$$

The speaker identifier updating unit 28 calculates the distributions of the claimed speaker and the background speaker from the sufficient statistics 30, 31 of the hypothesis score vector distributions with the claimed speaker's class label of y=+1 and y=−1 stored in the hypothesis score distribution storage part 27, calculates the unidimensional projection in the M-dimensional space where the separation of the two classes becomes the optimum, and updates the claimed speaker identifier having the M-dimensional vector in the projection direction as “αm” of the claimed speaker stored in the speaker identifier storage part 26.

For example, when it is assumed that the hypothesis score distribution is the M-dimensional normal distribution, the M-dimensional normal distributions are calculated respectively from the sufficient statistics 30, 31 with the claimed speaker's class label of y=+1 and y=−1 stored in the hypothesis score distribution storage part 27. Then, the M-dimensional vectors in the projection direction are obtained from the normal distributions of the two classes by linear discriminating analysis, and the vector having the norm normalized as “1” is taken as the weight am of the speaker identifier of the claimed speaker stored in the speaker identifier storage part 26 for updating the claimed speaker identifier.

When the distribution of the set of the hypothesis score vectors is not hypothesized, the M-dimensional vectors in the projection direction are obtained by linear discriminating analysis as an optimum separation problem of the two classes in the M-dimensional space, which is taken as the weight am of the identifier of the claimed speaker for updating the claimed speaker identifier.

As still another alternative, in the M-dimensional hypothesis score vector space, the weight “αm” is calculated to minimize the loss function (see Expression 3) on the distributions of the two classes or the data string for updating the claimed speaker identifier.

The speaker registering apparatus 20 shown in FIG. 4 is built as the structure of hardware in the above. However, the speaker registering apparatus 20 may be constituted with a computer, and have the CPU of the computer read out a program for generating the speaker identifier update data and a program for updating the speaker identifier successively, and executes the functions of the voice analyzing unit 22, the speaker verifying unit 23, the hypothesis score distribution updating unit 25, and the speaker identifier updating unit 28. In that case, the voice input part 21 is constituted with an acousto-electric converter in order to capture the voice data into the computer. Furthermore, the storage device 29 containing the speaker identifier storage part 26 and the hypothesis score distribution storage part 27 is constituted with a hard disk drive, for example.

(Operations of Speaker Registering Apparatus 10 and Speaker Verifying Apparatus 20)

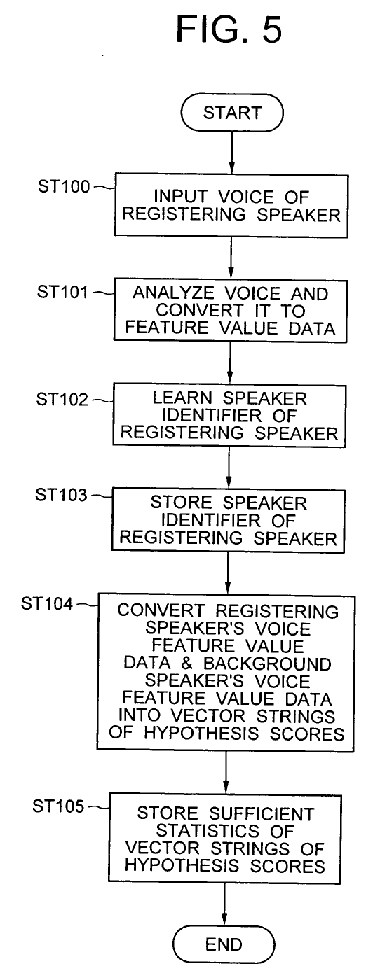

FIG. 5 is a flowchart for showing the operation of the speaker registering apparatus 10.

When the voice of the registrant is inputted to the voice input part 11 (ST100), the voice analyzing unit 12 analyzes the voice and converts it to the feature value data (ST101). The speaker identifier learning unit 13 learns the speaker identifier of the registering speaker using the voice feature value data of the registering speaker obtained from the voice analyzing unit 12 and the voice feature value data of the background speakers read out from the background speaker data storage part 14 (ST102). The speaker identifier learning unit 13 stores the speaker identifier to the speaker identifier storage part 15 (ST103).

The hypothesis score distribution calculating unit 17 converts the feature value data obtained form the voice analyzing unit 12 and the background speakers' voice feature value data read out from the background speaker data storage part 14 into the vector strings of a plurality of hypothesis scores that constitute the speaker identifier of the registering speaker (ST104). The hypothesis score distribution calculating unit 17 calculates the sufficient statistics of the distributions of the hypothesis score vector space and stores them to the hypothesis score distribution storage part 16 (ST105).

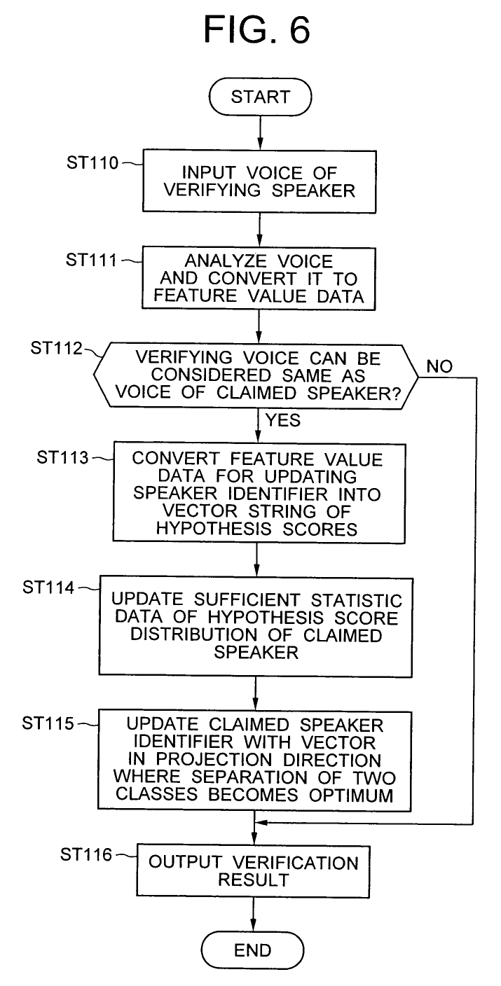

FIG. 6 is a flowchart for showing the operation of the speaker verifying apparatus 20.

When the verifying voice is inputted to the voice input part 21 (ST110), the voice analyzing unit 22 analyzes the voice and converts it to the feature value (ST111).

The speaker verifying unit 23 inputs the feature value data to the identifier H(x) of the claimed speaker, for example, and compares the output score thereof with the threshold value for judging whether or not the verifying voice can be considered as the same voice as that of the claimed speaker (ST112). When it is judged that the voices are not of the same speaker's, the verification result is outputted and the processing is ended (NO in ST112, and shifted to ST116).

When the speaker verifying unit 23 judges that the verifying voice is that of the claimed speaker's (YES in ST112), the hypothesis score distribution updating unit 25 updates the sufficient statistic stored in the hypothesis score distribution storage part 27.

First, the hypothesis score distribution updating unit 25 inputs the feature value data of the verifying voice to the speaker identifier of the claimed speaker, and converts it to the vector string of the hypothesis scores (ST113). The hypothesis score distribution updating unit 25 calculates the sufficient statistic of the distribution in the hypothesis score vector space of the calculated vectors, which is combined with the sufficient statistic 30 of the hypothesis score distribution with the class label y=+1 of the claimed speaker stored in the hypothesis score distribution storage part 16 for update (ST114).

Next, the speaker identifier updating unit 28 uses the updated sufficient statistic 30 to update the speaker identifier of the claimed speaker (ST115). Specifically, the distributions of the claimed speaker and the background speaker are calculated from the sufficient statistics 30, 31 of the hypothesis score vector distributions with the class labels of y=+1, y=−1 of the claimed speaker stored in the hypothesis score distribution storage part 16. Then, there is calculated the unidimensional projection in the M-dimensional space where the separation of the two classes becomes the optimum, and the claimed speaker identifier is updated having the M-dimensional vector in the projection direction as “αm” of the speaker identifier of the claimed speaker stored in the speaker identifier storage part 15.

At last, the verification result output part 25 outputs the verification result, and the verifying processing is ended (ST116).

The present invention can be embodied also as a program of the computer for executing each of the above-described processing.

In the speaker verifying system 1, the hypothesis score vector distribution calculating unit 17 of the speaker registering apparatus 10 calculates the score vector string of the registering speaker and the score vector string of the background speakers at the time of registering the speaker, and stores the sufficient statistics of those data in the hypothesis score distribution storage part 16 as the sufficient statistics 30 and 31.

At the time of verifying the speaker, the hypothesis score distribution updating unit 25 of the speaker verifying apparatus 20 updates the sufficient statistic 30 stored in the hypothesis score distribution storage part 27 based on the voice of the verifying speaker inputted at the time of verification.

Furthermore, the speaker identifier updating unit 28 updates the weighting function of the speaker identifier of the verifying speaker based on the sufficient statistic 31 and the updated sufficient statistic 30.

As described above, the information necessary for updating the speaker identifier is stored in the form of the sufficient statistics. Thus, the amount of stored data can be reduced compared to the case where the feature values of the voices of the background speakers are stored as they are.

Furthermore, at the time of verifying the speaker, the voice that has been successfully authenticated is used to update the hypothesis weight am without changing the hypothesis hm(x) that constitutes the speaker identifier in order to update the speaker identifier. Thus, the amount of calculation for updating the speaker identifier can be reduced compared to the case of updating the hypothesis.

That is, with the speaker verifying system 1, it is possible to achieve update of the identifier of the registering speaker at a low cost while considering the change in the voice of the speaker over time.

What is claimed is:

1. An update data generating apparatus for generating speaker identifier update data that is used for updating a speaker identifier constituted with weighted sum of a plurality of hypotheses, the update data generating apparatus comprising an update data generating unit that comprises functions of:
inputting registering speaker's voice feature value data to the speaker identifier of a registering speaker, obtaining hypothesis scores as outputs of the plurality of hypotheses, and generating a score vector string of the registering speaker constituted with a plurality of vectors having the hypothesis scores as elements;
inputting background speaker's voice feature value data to the speaker identifier of the registering speaker, obtaining hypothesis scores as outputs of the plurality of hypotheses, and generating a score vector string of the background speaker constituted with a plurality of vectors having the hypothesis scores as elements; and
storing the score vector string of the registering speaker and the score vector string of the background speaker to a storage device.

2. The update data generating apparatus as claimed in claim 1, wherein the update data generating unit calculates sufficient statistics of distributions in vector spaces of the score vector string of the registering speaker and the score vector string of the background speaker.

3. The update data generating apparatus as claimed in claim 2, wherein the sufficient statistics contain: number of the registering speaker's voice feature value data; number of the background speaker's voice feature value data; an average value of the score vector string of the registering speaker; an average value of the score vector string of the background speaker; an average value of vectors obtained by multiplying score vectors of the registering speaker and inverted vectors of the vectors; and an average value of vectors obtained by multiplying score vectors of the background speaker and inverted vectors of the vectors.

4. A speaker verifying apparatus that comprises, for each registering speaker, a speaker identifier storage part to which a speaker identifier constituted with weighted sum of M-number of hypotheses is stored in advance and a speaker verifying unit for performing speaker verification through the speaker identifier, the speaker verifying apparatus comprising:
an update data storage part having stored, in advance, a registering speaker score vector string constituted with a plurality of vectors having, as elements, hypothesis scores that can be obtained as an output of a plurality of hypotheses by inputting registering speaker's voice feature value data to a speaker identifier of a registering speaker and a background speaker score vector string constituted with a plurality of vectors having, as elements, hypothesis scores that can be obtained as an output of a plurality of hypotheses by inputting background speaker's voice feature value data to the speaker identifier of the registering speaker;
an update data updating unit comprising functions of: generating a verifying speaker score vector string constituted with a plurality of vectors having, as elements, hypothesis scores that can be obtained as an output by inputting voice feature value data of the verifying speaker to each of the hypotheses constituting the speaker identifier of the verifying speaker, when the speaker verifying unit judges that the verifying speaker claims as he or she is a legitimate speaker; and updating the registering speaker score vector string by combining the generated vector string to the registering speaker score vector string; and
a speaker identifier updating unit comprising functions of: obtaining M-dimensional vectors in a projection direction by applying an optimum separating problem of two classes in a M-dimensional space to the registering speaker score vector string and the background speaker score vector string; and updating the speaker identifier of the verifying speaker by using each element of the obtained vectors as the weight.

5. The speaker verifying apparatus as claimed in claim 4, wherein:
the update data storage part has sufficient statistics of distributions in vector spaces of the registering speaker score vector string and the background speaker score vector string stored therein; and
the speaker identifier updating unit comprises a function of calculating score vector distributions of the verifying speaker and the background speaker based on the sufficient statistics.

6. The speaker verifying apparatus as claimed in claim 5, wherein
the sufficient statistics are: number of the registering speaker's voice feature value data; number of the background speaker's voice feature value data; an average value of the score vector string of the registering speaker; an average value of the score vector string of the background speaker; an average value of vectors obtained by multiplying score vectors of the registering speaker and inverted vectors of the vectors; and an average value of vectors obtained by multiplying score vectors of the background speaker and inverted vectors of the vectors, and
the speaker identifier updating unit: generates M-dimensional normal distributions of the registering speaker score vector string and the background speaker score vector string from the sufficient statistics; calculates, based on the M-dimensional normal distributions, unidimensional projection where separation of the registering speaker score vector string and the background speaker score vector string becomes optimum; and uses, as the weight, each element of vectors obtained by normalizing norm of M-dimensional vectors indicating direction of the projection as “1”.

7. A method for generating speaker identifier update data that is used for updating a speaker identifier constituted with weighted sum of a plurality of hypotheses, comprising the steps of:
obtaining registering speaker's voice feature value data and inputting the registering speaker's voice feature value data to the speaker identifier of a registering speaker to obtain hypothesis scores as an output of the plurality of hypotheses, and generating a registering speaker score vector string constituted with a plurality of vectors having the hypothesis scores as elements;
obtaining background speaker's voice feature value data and inputting the background speaker's voice feature value data to the speaker identifier of the registering speaker to obtain hypothesis scores as an output of the plurality of hypotheses, and generating a background speaker score vector string constituted with a plurality of vectors having the hypothesis scores as elements; and
calculating sufficient statistics of distributions in vector spaces of the registering speaker score vector string and the background speaker score vector string, and recording the sufficient statistics to a storage device as the speaker identifier update data.

8. A method for updating a speaker identifier constituted with weighted sum of a plurality of hypotheses, comprising the steps of:
a speaker verifying step for judging legitimacy of a verifying speaker by using the speaker identifier;
inputting voice feature value data of the verifying speaker to the speaker identifier of the verifying speaker to obtain hypothesis scores as an output result thereof when legitimacy of the verifying speaker is confirmed in the speaker verifying step, and generating verifying speaker score vector string constituted with a plurality of vectors having the hypothesis scores as elements;
a sufficient statistic calculating step for calculating verifying speaker sufficient statistic that shows distribution in a vector space of the verifying speaker score vector string;
an update data updating step for updating update data by combining verifying speaker sufficient statistic and the update data stored in a storage device in advance, and storing the updated update data to the storage device;
a distribution calculating step for calculating distributions of the verifying speaker and a background speaker based on the update data that is updated in the update data updating step; and
a speaker identifier updating step for calculating, based on the distributions, unidimensional projection where separation of the registering speaker score vector and the background speaker score vector becomes optimum, and updating the speaker identifier of the verifying speaker by using each element of the vector indicating direction of the projection as the weight

9. A program for generating speaker identifier update data that is used for updating a speaker identifier constituted with weighted sum of a plurality of hypotheses, which is used in a computer to execute functions of:
obtaining registering speaker's voice feature value data and inputting the registering speaker's voice feature value data to the speaker identifier of a registering speaker to obtain hypothesis scores as an output of the plurality of hypotheses, and generating a registering speaker score vector string constituted with a plurality of vectors having the hypothesis scores as elements;
obtaining background speaker's voice feature value data and inputting the background speaker's voice feature value data to the speaker identifier of the registering speaker to obtain hypothesis scores as an output of the plurality of hypotheses, and generating a background speaker score vector string constituted with a plurality of vectors having the hypothesis scores as elements; and
calculating sufficient statistics of distributions in vector spaces of the registering speaker score vector string and the background speaker score vector string, and recording the sufficient statistics to a storage device as the speaker identifier update data.

10. A program for updating a speaker identifier constituted with weighted sum of a plurality of hypotheses, which is used in a computer for executing functions of:
a speaker verifying function for judging legitimacy of a verifying speaker by using the speaker identifier;
inputting voice feature value data of the verifying speaker to the speaker identifier of the verifying speaker to obtain hypothesis scores as an output result thereof when legitimacy of the verifying speaker is confirmed by the speaker verifying function, and generating verifying speaker score vector string constituted with a plurality of vectors having the hypothesis scores as elements;
a sufficient statistic calculating function for calculating verifying speaker sufficient statistic that shows distribution in a vector space of the verifying speaker score vector string;
an update data updating function for updating the update data by combining verifying speaker sufficient statistic and the update data stored in a storage device in advance, and storing the updated update data to the storage device;
a distribution calculating function for calculating distributions of the verifying speaker and a background speaker based on the update data that is updated by the update data updating function; and
a speaker identifier updating function for calculating, based on the distributions, unidimensional projection where separation of the registering speaker score vector and the background speaker score vector becomes optimum, and updating the speaker identifier of the verifying speaker by using each element of the vectors indicating direction of the projection as the weight.
